(19) United States
(12) Patent Application Publication
(10) Pub. No.: US 2022/0414486 A1
(43) Pub. Date: Dec. 29, 2022

(54) Predictor and Method

(71) Applicant: Nippon Telegraph and Telephone Corporation, Tokyo (JP)

(72) Inventors: Shingo Mineta, Musashino-shi, Tokyo (JP); Takuya Otsuka, Musashino-shi, Tokyo (JP); Shota Oki, Musashino-shi, Tokyo (JP); Mamoru Mizunuma, Musashino-shi, Tokyo (JP); Masayuki Tsuda, Musashino-shi, Tokyo (JP)

(21) Appl. No.: 17/778,273

(22) PCT Filed: Nov. 22, 2019
(86) PCT No.: PCT/JP2019/045784

§ 371 Date: May 19, 2022

(51) Int. Cl. G06N 5/02

(52) U.S. Cl. CPC G06N 5/022

(57) ABSTRACT

A prediction device that predicts an objective variable desired to be predicted in a predetermined environment by using two or more prediction models, the prediction device including: a first prediction model configured to output a characteristic representing a relationship with an event related to the objective variable from a change in a factor of the environment; and a second prediction model configured to output information regarding an amount of change of the objective variable from the characteristic and an explanatory variable characterizing the environment.

### TECHNICAL FIELD

The present invention relates to a prediction device that predicts a relationship between an explanatory variable associated with an environmental factor and an objective variable corresponding to, for example, a degree of deterioration, and a method therefor.

### BACKGROUND ART

A method for predicting and estimating the life and deterioration state of a social infrastructure based on information of equipment environment is being advanced. In a case where an infrastructure that exists underground and is difficult to see is a target among social infrastructures, the underground is an environment that is not visible. Further, deterioration mechanisms in the ground are very complicated.

Thus, in the related art, for example, an objective variable such as an amount of reduced thickness of equipment (metal) embedded in the ground is predicted by obtaining a resistance value corresponding to reaction resistance of corrosion using an AC impedance method, and estimating the corrosion rate on the basis of the numerical value, and obtaining the amount of reduced thickness of metal representing the degree of deterioration of the metal, or the like from the estimated corrosion rate (NPL 1).

### CITATION LIST

### Non Patent Literature

NPL 1: Fei Qin et al., “Effect of soil moisture content on corrosion behavior of X70 steel”, Int. J. Electrochem. Sci., 13 (2018) 1603 to 1613, doi: 10.20964/2018.02.32

### SUMMARY OF THE INVENTION

### Technical Problem

However, devices having an electrochemical measurement function by AC impedance method are often expensive and large. Further, a voltage or current frequency sweep is necessary for the measurement, and the time required for a single measurement is long. Furthermore, since voltage is applied, even though it is minute, the surface state of an object to be measured can also be changed when continuous measurement is performed for a long period of time. Thus, unfortunately, the electrochemical measurement by the AC impedance method is not suitable, for example, for a case where there are many targets or points where the amount of reduced thickness is desired to be predicted, a case where the measurement period is long, or the like.

Further, when data with sufficient quality and amount cannot be obtained for prediction of the objective variable corresponding to the degree of deterioration, unfortunately, it is often difficult to build a useful prediction model even if it is simply attempted to obtain the relationship between the data related to an environmental factor (explanatory variable) and a corrosion rate (objective variable) representing, for example, the degree of deterioration, using a statistical technique and a machine learning model.

The present invention has been made in view of the above problems, and has an object to provide a prediction device that enables useful prediction even in cases where it is difficult to measure, or predict using a measurement or statistical technique and a machine learning model, the relationship between an explanatory variable and an objective variable, and a method therefor.

### Means for Solving the Problem

The gist of a prediction device according to one aspect of the present invention is that a prediction device that predicts an objective variable desired to be predicted in a predetermined environment by using two or more prediction models includes: a first prediction model configured to output a characteristic representing a relationship with an event related to the objective variable from a change in a factor of the environment; and a second prediction model configured to output information regarding an amount of change of the objective variable from the characteristic and an explanatory variable characterizing the environment.

Further, the gist of a prediction method according to one aspect of the present invention is that a prediction method performed by a prediction device includes: outputting a characteristic representing a relationship with an event related to an objective variable desired to be predicted in a predetermined environment and time by using a first prediction model representing a relationship with the event from a change in an environmental factor of the environment; and outputting the amount of change of the objective variable using a second prediction model that outputs information regarding the amount of change of the objective variable from the characteristic and an explanatory variable characterizing the environment.

### Effects of the Invention

According to the present invention, it is possible to enable useful prediction even in cases where it is difficult to simply model a relationship between an explanatory variable and an objective variable using a statistical technique and a machine learning model.

### BRIEF DESCRIPTION OF DRAWINGS

FIG. 1 is a diagram schematically illustrating a relationship between rainfall and fluctuation of water content.

FIG. 2 is a diagram schematically illustrating examples of the characteristics of corrosion rates of a metal in soil at different water contents.

FIG. 3 is a diagram schematically illustrating a change in corrosion rate when water content is changed over time.

FIG. 4 is a diagram illustrating a conceptual configuration diagram of a prediction device that predicts an amount of change of an objective variable using three prediction models.

FIG. 5 is a diagram illustrating a functional configuration example of a prediction device 200 according to a first embodiment of the present invention.

FIG. 6 is a diagram illustrating an operation flowchart of a prediction method executed by the prediction device 200 illustrated in FIG. 5.

### DESCRIPTION OF EMBODIMENTS

Hereinafter, embodiments of the present invention will be described with reference to the accompanying drawings. The same reference signs are given to the same constituent elements which are the same in the plurality of drawings, and description thereof is not repeated.

The present invention relates to a prediction device for predicting an objective variable from an explanatory variable by combining two or more prediction models, and a method therefor. One of the prediction models specifies information to be input and information to be output on the basis of scientific phenomenology of a prediction target. In the following, the present invention will be described by way of example of a prediction device that predicts corrosion of underground equipment made of metal.

As infrastructure equipment, there are many pieces of underground equipment made of metal that are used in a state in which all or part thereof is embedded in the ground, as exemplified by steel tube columns, support anchors, underground steel piping, and the like. These pieces of underground equipment corrode because of contact with the soil, and deteriorate at different speeds depending on the underground environment. Therefore, in order to ensure and efficiently maintain safety and security of the equipment, for example, it is necessary to perform maintenance appropriately by quantitatively evaluating corrosion properties of the underground environment and by accurately predicting the progress of corrosion.

Examples of methods for predicting the progress of corrosion of underground equipment include the following methods. One is a method of predicting by a theoretical model on the basis of corrosion engineering. Another is a method of deriving a prediction expression for the progress of corrosion by statistical analysis of a value corresponding to a corrosion amount (objective variable) such as a corrosion depth obtained by inspection, local research, or the like, and environmental factors (explanatory variables) such as chemical analysis values and geographical information of the soil that are thought to contribute to corrosion. However, for the reasons described below, it is difficult to build an accurate prediction model suitable for the actual situation in either of the methods.

One of the factors that make it difficult to build the prediction model is that the complexity of the underground environment causes delayed organization of knowledge related to the underground corrosion. The ground is an environment in which three phases coexist, which are a solid phase such as earth particles, a liquid phase such as water that exist in gaps of the earth particles, and a vapor phase containing oxygen, carbon dioxide, and the like that also exist in the gaps. Further, the proportion of water (liquid phase) and oxygen (vapor phase) that contribute directly to corrosion reactions fluctuates with weather conditions such as rainfall. Furthermore, chemical species present in the ground and the proportions thereof differ depends on the type of earth, and also vary depending on activities of plants, microorganisms, and the like. As described above, because the underground is a very complicated environment in view of corrosion, it is difficult to find the relationship between environmental factors in the ground and a corrosion rate, and formulate a general purpose theory that can be understood by humans, and very little practical prediction method has been proposed in the current situation.

Another factor is that data related to environmental factors in the ground and data related to the deterioration of underground equipment are difficult to obtain. Because the underground equipment is present in the ground, it is basically not visible. Thus, the quality and amount of data that can be acquired is often not sufficient for analysis. Therefore, even if the relationship between the data related to the environmental factors (explanatory variables) and the data related to deterioration (objective variables) corresponding to, for example, the corrosion amount is simply analyzed using, for example, a statistical technique, a machine learning algorithm, or the like, it is often difficult to build a useful prediction model.

The soil is a three-phase coexistence environment composed of soil particles including oxides of Si, Al, Ti, Fe, Ca, and the like, and a vapor phase (such as oxygen) and a liquid phase (such as water) present in gaps thereof. Given that the ratio of gaps in the soil is constant, the sum of the proportion of the gas phase and the ratio of the liquid phase in the soil is constant, and there is a contradictory relationship in which if one is higher, the other is lower. Because water and oxygen are basically required for corrosion reactions of metals in a neutral environment such as the underground, corrosion rates vary primarily depending on the following three elements.

One is a state element of the liquid phase such as chemical reaction species contained in a liquid phase (water) in the soil and an amount thereof. Another is an element of water content indicating the ratio of the liquid phase to the vapor phase occupying the gaps of the soil particles. Furthermore, there is a state element of the gas phase, such as the proportion of oxygen occupied in the vapor phase in the soil.

A typical factor for changing the underground environment including the three elements described above is rainfall. The soil increases in water content (becomes wet) during rainfall and gradually decreases (dries) when the rain stops.

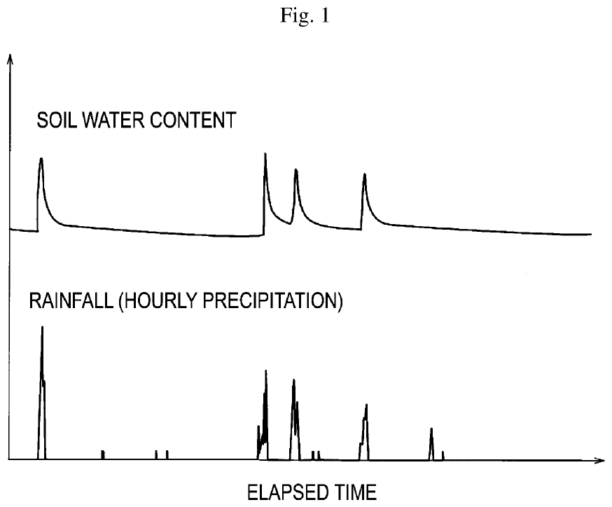

FIG. 1 is a diagram schematically illustrating the relationship between rainfall and fluctuation of water content. The horizontal axis in FIG. 1 is time. As illustrated in FIG. 1, it can be seen that water content increases/decreases in close conjunction with the rainfall, and repeat cycles of rapidly increasing during rainfall, and gradually decreasing when the rain stops. That is, the water content needs to be considered as an element that fluctuates with rainfall. Because the corrosion rate of a metal in the underground environment also changes depending on the water content of the soil, it is important to grasp a process of the soil from the wet state to the dry state as a single indicator when the corrosion rate is considered.

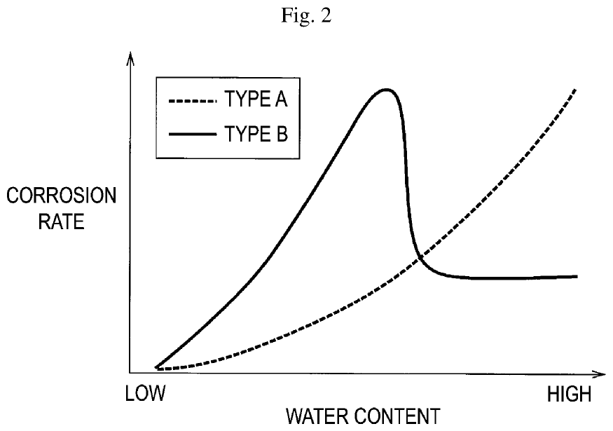

According to previous studies, it has been found that the corrosion rates of a metal in the soil at different water contents describe a curve, for example, as illustrated in FIG. 2. The horizontal axis in FIG. 2 is the water content and the vertical axis is the corrosion rate.

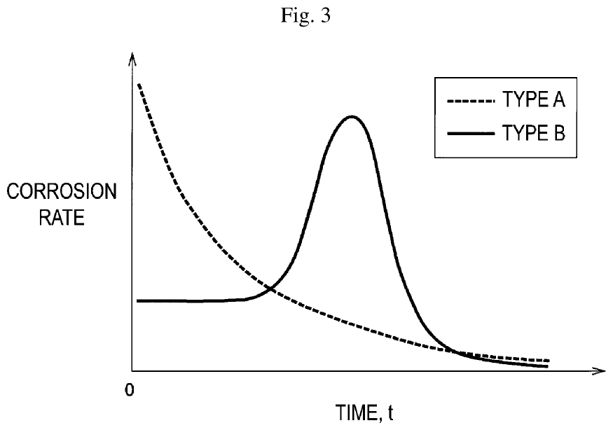

FIG. 3 is a diagram schematically illustrating a change in corrosion rate when the water content is changed over time. The horizontal axis in FIG. 3 is time t. A state where the soil gaps are saturated in the liquid phase is at t=0, indicating a change in corrosion rate over time as drying progresses with time t.

Here, the curves of type A and type B illustrated in FIG. 3 are considered. In the type A, the corrosion rate decreases over time with its maximum at t=0. On the other hand, the type B exhibits a characteristic behavior such that the corrosion rate is almost unchanged in a high water content range at around t=0, but after a certain time, the corrosion rate increases and reaches a maximal and then turns to decrease. The corrosion rate in the soil at which the water content changes over time indicates different behaviors depending on the soil, and a characteristic of the soil itself can be read from this curve.

Note that the characteristic of the soil can be read similarly from the curve of the corrosion rate with respect to the water content illustrated in FIG. 2, but will be described here with reference to FIG. 3.

For example, in the soil exhibiting a curve similar to the type A, the corrosion rate is higher when the water content is higher, and thus this soil can be interpreted as having a characteristic such that the corrosion proceeds more in an environment where wet time is longer. On the other hand, the type B has a relatively low corrosion rate when the water content is high, but the corrosion rate becomes maximal when drying proceeds and the water content becomes somewhat low. That is, the soil of the type B can be interpreted as having the characteristic of being corroded under circumstances where certain degree of dry conditions is maintained.

For example, in a case of an environment where a wet state is maintained, such as a region having high rainfall frequency, it can be estimated that the corrosion proceeds more in the metal embedded in the type A soil than in the type B soil. Also, for example, in an environment in which a certain degree of dry state is maintained, such as a region where rainfall frequency is low, it can be estimated that the corrosion proceeds more in the metal embedded in the type B soil than in the type A soil.

That is, as illustrated in FIG. 2 and FIG. 3, information related to the corrosion rates of the metal in the soil at different water contents includes soil specific characteristic and is directly related to the environmental factors in the ground. In particular, it has been found that it is closely related to a soil particle size distribution. Further, for example, the type of soil, the color of the soil, the conductivity, the chemical reaction species, the amount thereof, and the like are also greatly related. Therefore, the information related to the corrosion rates of the metal in the soil at different water contents can be estimated from a first prediction model representing the relationship with the environmental factors in the ground including information related to the soil particle size distribution.

The first prediction model outputs a characteristic representing a relationship between an event related to the objective variable and time from a change in an environmental factor over time. The output here may be rephrased as estimation or prediction. Note that the first prediction model may output, from a change in a factor of the environment, a characteristic representing a relationship with an event related to the objective variable. That is, the first prediction model does not need to be a model that outputs a characteristic representing the relationship between an event and time related to a change over time.

On the other hand, for example, even in the same type A soil, metal corrosion proceeds at different rates when the environment in which the soil is placed is different. Therefore, in order to predict the progress of corrosion in the underground equipment, it is effective to derive a second prediction model representing the relationship between information combining information that characterizes the environment in which the soil exists, and information regarding deterioration such as a corrosion amount, in addition to the information related to the corrosion rates of a metal in the soil at different water contents including the soil specific characteristic. The information that characterizes the environment in which the soil exists may include, for example, rainfall frequency, the depth of embedding the target equipment, pavement conditions of the surface layer, elapsed years of the equipment, and the like.

The second prediction model outputs information regarding the amount of change of the objective variable from a characteristic output by the first prediction model and the explanatory variable characterizing the environment. The output here may be rephrased as estimation or prediction similarly to those of the first prediction model.

For example, if there is sufficient quality and quantity of data, there is a possibility to model a direct relationship for predicting information related to deterioration of the underground equipment from an environmental factor in the ground by simply using, for example, a statistical technique, a machine learning algorithm, or the like. However, as described above, because the relationship between the underground environment and the deterioration (corrosion) of metal is very complicated, and data with sufficient quality and amount are often not obtained, it is difficult to model the direct relationship between the environmental factors in the ground and the information related to deterioration of the underground equipment by simply using a statistical technique or a machine learning algorithm. Therefore, on the basis of knowledge related to the underground corrosion phenomena described above, by deriving the first prediction model and the second prediction model using the statistical technique, the machine learning algorithm, or the like in advance, it becomes possible to predict the information related to deterioration of the underground equipment from the environmental factors in the ground.

The prediction model is not limited to two of the first prediction model and the second prediction model. Three or more prediction models may be used.

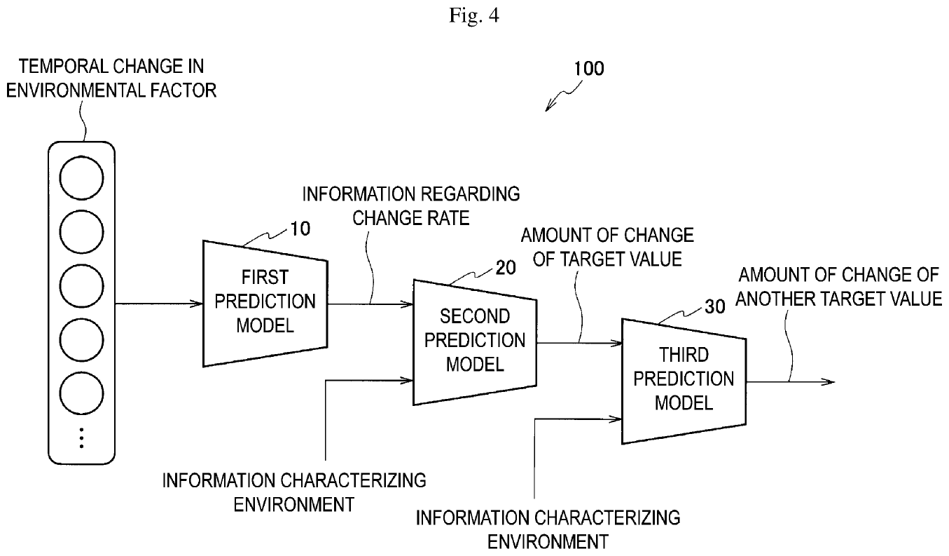

FIG. 4 illustrates a conceptual configuration diagram of a prediction device that predicts an amount of change of the objective variable using three prediction models. The prediction device 100 illustrated in FIG. 4 includes a first prediction model 10, a second prediction model 20, and a third prediction model 30.

The first prediction model 10 outputs a characteristic representing a relationship between an event related to the objective variable and time from a change in an environmental factor over time. This characteristic is a characteristic representing, for example, a change in time and corrosion rate illustrated in FIG. 3.

The second prediction model 20 outputs information regarding the amount of change of a target value (objective variable) from characteristics representing the relationship between an event related to the objective variable predicted in the first prediction model 10 and time and information (explanatory variable) characterizing the environment. The information regarding the amount of change of the objective variable is, for example, the amount of reduced thickness of metal due to corrosion.

The third prediction model 30 outputs information regarding the amount of change of another target value (objective variable) from information regarding the amount of change of the target value predicted in the second prediction model 20 and the information (explanatory variable) characterizing the environment. The information regarding the amount of change of another objective variable is, for example, strength of the metal for which the amount of reduced thickness is predicted.

### First Embodiment

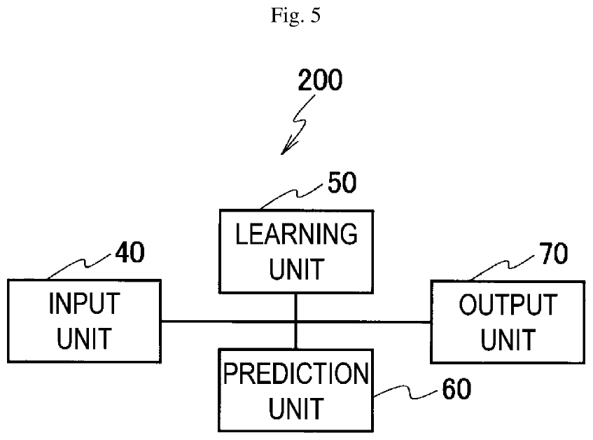

FIG. 5 is a diagram illustrating a functional configuration example of a prediction device 200 according to a first embodiment of the present invention. The prediction device 200 illustrated in FIG. 1 is, for example, a device that predicts a corrosion rate related to the amount of reduced thickness of corroded metal from, for example, changes in underground environmental factors including information related to the soil particle size distribution, and further predicts the amount of reduced thickness by corrosion from the predicted corrosion rate.

The prediction device 200 includes an input unit 40, a learning unit 50, a prediction unit 60, and an output unit 70. The prediction device 200 can be achieved by, for example, a computer including a ROM, a RAM, a CPU, and the like.

The input unit 40 provides the information related to the soil particle size distribution to the learning unit 50. The input unit 40 is, for example, an input port of a computer.

The learning unit 50 derives the first prediction model 10 including a relationship between the information related to the environmental factors in the ground and the information related to the corrosion rate of the metal, and derives the second prediction model 20 including a relationship between the information including “at least one of the information related to the corrosion rate of the metal”, and information related to deterioration.

The prediction unit 60 outputs, on the basis of the first prediction model 10, a characteristic representing a relationship between an event related to an objective variable and time from a change in an environmental factor over time, and outputs information regarding the amount of change of the objective variable from the characteristic and the explanatory variable characterizing the environment.

The first prediction model outputs a characteristic representing a relationship between a temporal change in a factor of a soil environment and information related to a corrosion rate of a metal disposed in the soil environment. The second prediction model outputs information related to a corrosion amount of the metal from the characteristics and information characterizing the soil environment. Thus, it is possible to provide a prediction device and method therefor that enables useful prediction even in cases where it is difficult to perform prediction using a statistical technique and a machine learning model.

The output unit 70 outputs, to the outside, the amount of reduced thickness by corrosion predicted by the prediction unit 60. The output unit 70 is, for example, a computer display. Alternatively, the amount of reduced thickness by corrosion is output to another device such as a printer.

With the prediction device 200 according to the present embodiment described above, even in cases where the relationship between the explanatory variable and the objective variable is difficult to be simply modeled using the statistical technique and the machine learning model.

### Prediction Method

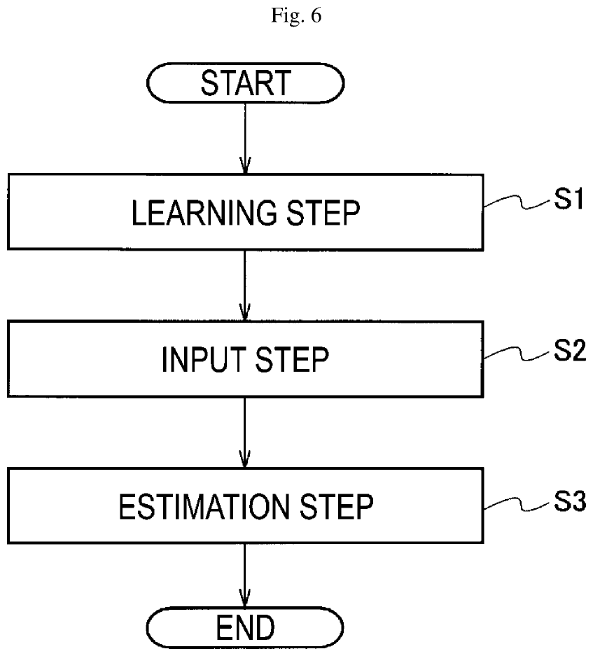

FIG. 6 is a diagram illustrating an operation flowchart of a prediction method executed by the prediction device 200. As illustrated in FIG. 6, the prediction method according to the present embodiment includes a learning step S1, an input step S2, and a prediction step S3. In the learning step S 1, the first prediction model 10 is derived that receives, as inputs, information related to an environmental factor in the ground including at least the information related to the soil particle size distribution, and outputs information related to the corrosion rates of the metal including at least information related to the corrosion rate of the metal in the soil at different water contents. Furthermore, in the learning step S1, a prediction model 2 is derived that receives, as inputs, information including at least one piece of information related to the corrosion rates of the metal and outputs information related to the deterioration. Further, in the learning step S1, the first prediction model 10 and the second prediction model 20 are built. In the input step S2, among the information related to the environmental factors in the ground including at least the information related to the soil particle size distribution, and information including at least one piece of information related to the corrosion rate of the metal, information other than information related to the corrosion rate of the metal is input. In the prediction step S3, information related to deterioration is predicted from the information input in the input step S2 on the basis of the first prediction model 10 and the second prediction model 20 built in the learning step.

The prediction step S3 includes a first prediction step of outputting a characteristic representing a relationship with an event related to an objective variable desired to be predicted in a predetermined environment and time by using a first prediction model representing a relationship with the event from a change in an environmental factor of the environment over time, and a second prediction step of outputting the amount of change of the objective variable using a second prediction model that outputs information regarding the amount of change of the objective variable from the characteristic and an explanatory variable characterizing the environment.

In the learning step S1, the first prediction model 10 is derived that includes the relationship between the information related to the environmental factors in the ground including at least the information related to the soil particle size distribution and information related to the corrosion rate of the metal including at least information related to the corrosion rates of the metal in the soil at different water contents.

The information related to the particle size distribution of the soil is only required to be information including the information of the particle size distribution of the soil, and the type and form thereof are not particularly limited. For example, results obtained using a laser diffraction or scattering type particle size distribution measurement device may be used, and histogram information including particle size and frequency, information including particle size and cumulative probability, and the like are conceivable. Further, for example, an image obtained by image-capturing the soil using an optical microscope, SEM, or the like, particle size distribution information extracted from these images, and the like may be used.

The types, forms, and the like of information other than the information related to the soil particle size distribution are not particularly limited as the information related to the environmental factors in the ground, but it is preferable to use information that reflects the chemical and electrical characteristics of the soil. For example, in the present embodiment, soil color information is considered. For example, the soil at the target point desired to be predicted may be image-captured using an optical camera or the like, and numerical information of RGB or HSV extracted from the image may be used. In addition, classification information such as the type of soil is conceivable, and categorical information such as, for example, andosol and brown lowland soil in a soil series group may be used. Of course, the classification method is not limited to information of the type of soil. In addition, information such as, for example, conductivity of the soil may be used. A method for measuring the electrical conductivity of the soil is omitted here, but it can be easily measured using a typical meter.

The information related to the corrosion rates of the metal in the soil at different water contents is only required to be information including the relationship between the water content of the soil and the corrosion rate of the metal, and the form thereof is not particularly limited. For example, as described above, curve information representing the relationship of the corrosion rates with respect to the water contents or the values corresponding to the corrosion rates, curve information representing the relationship of the corrosion rate with respect to the elapsed time when the water content is changed over time, and the like are conceivable. Further, the variable information obtained by fitting these curves with any function may be used as the characteristic amount.

Here, the method for acquiring and inputting information related to the corrosion rates of the metal in the soil at different water contents is not particularly limited. For example, for the curve information representing the relationship of the corrosion rates with respect to the water contents or the values corresponding to the corrosion rates, or the curve information representing the relationship of the corrosion rates with respect to the elapsed time when the water content is changed over time, a method to simply measure experimentally by an electrochemical measurement such as an impedance method is conceivable. For example, an electrode including a target metal is embedded in any soil, and water is introduced into the soil to cause saturation. The change in the corrosion rate is then measured during the course of drying by draining or the like. At this time, for example, when an impedance method with two electrodes is used, it is possible to acquire information of a value corresponding to reaction resistance of corrosion from a Cole-Cole plot obtained by applying an alternating voltage between two metals provided in the electrodes and sweeping the frequency by a predetermined range, and estimate, from this value, a values corresponding to the corrosion rates at the moment of measurement. Therefore, by performing the electrochemical measurement according to this impedance method in the soil with varying water content, the curve information representing the relationship of the corrosion rate with respect to the water content or the values corresponding to the corrosion rates, or the curve information representing the relationship of the corrosion rate with respect to the elapsed time when the water content is changed over time can be obtained.

The first prediction model 10 is derived by, for example, a method based on a statistical technique such as multivariate analysis or a machine learning algorithm, by using information related to the environmental factors in the ground including at least the information related to the soil particle size distribution as the explanatory variable, and information related to the corrosion rates of the metal in the ground at different water contents as the objective variable. Note that the statistical technique and the machine learning algorithm to be used are not particularly limited, but for example, analysis by a random forest, a support vector machine, or a neural network may be considered as the machine learning algorithm. Here, the amount of each piece of information used when deriving the first prediction model 10 is not particularly limited, but it is preferable to perform the analysis using the amount of information sufficient to derive the effective first prediction model 10. However, as described above, the environmental factor information in the ground is often not sufficiently obtained, but it is possible to respond by deriving the first prediction model 10 in advance as in the present embodiment, for example. That is, in the present embodiment, information related to the corrosion rates of the metal in the soil at different water contents is acquired in advance using various soil, and the first prediction model 10 is derived in advance using the information. The various soil used at this time is not particularly limited.

For example, by producing soils in which the soil particle size distribution and other characteristic values (such as conductivity and contained chemical species) are varied, acquiring environmental factor information in the ground in these soils, and further experimentally acquiring information related to the corrosion rates of the metal in the soil at different water contents by using these soils, the first prediction model 10 that is sufficiently significant can be derived in advance using, for example, the machine learning algorithm. Thus, by just acquiring the environmental factor information in the target point where it is desired to be predicted, the first prediction model 10 can be used to estimate the information related to the corrosion rates of the metal in the soil at different water contents.

Further, in the learning step S1, the second prediction model 20 is derived from the relationship between information including at least one piece of information related to the corrosion rate of the metal and the information related to deterioration.

Regarding the information including at least one piece of information related to the corrosion rate of the metal, the type of information and the form thereof is not particularly limited, but in addition to the information related to the corrosion rates of the metal in the soil at different water contents described above, for example, information characterizing the environment in which the soil is present is also preferably included. Conceivable examples of the information characterizing the environment in which the soil is present include rainfall frequency, vegetation, land usage classification information, the depth of embedding the equipment, underground temperature, pavement conditions of the ground layer of embedding location, elapsed years of the equipment, and the like at the point where the target equipment exists.

In the derivation of the second prediction model 20, it is effective to use the statistical technique or the machine learning algorithm, but the technique and the like are not particularly limited. For example, when using the machine learning algorithm, analysis by random followers, support vector machines, neural networks, and the like are conceivable as in the case of the first prediction model 10.

Further, in the present embodiment, it is preferable that the second prediction model 20 is derived in advance. The derivation procedure is also not particularly limited, but for example, the corrosion amount of actual underground equipment may be investigated, and the relationship with an information group including at least one piece of information related to the corrosion rate of the metal may be derived by analysis using the machine learning algorithm, or values in documents or the like may be used, for example. Further, for example, the following may be employed.

A target metal is embedded for any period of time in the various soil used in the derivation of the first prediction model 10, and the corrosion amount at that time is experimentally acquired as the information related to deterioration. At this time, it is possible to derive a more versatile model at the time of derivation of the second prediction model 20 by the machine learning algorithm by systematically allocating conditions such as, for example, embedding depth, rainfall or water supply conditions during embedding, temperature, surface conditions of the embedding soil, and the like, which are information characterizing the environment in which the soil exists. Note that the metal to be used is not particularly limited, but is preferably a constituent metal of the underground equipment desired to be predicted. Typically, a steel material or the like is conceivable. Thus, the first prediction model 10 and the second prediction model 20 are derived in the learning step S1.

Further, if the first prediction model 10 and the second prediction model 20 are already built and stored in advance, it is possible to omit the learning step S1.

In the input step S2, among the information related to the environmental factors in the ground including at least information related to the soil particle size distribution, and information including the information related to the corrosion rate of the metal, information other than information related to the corrosion rate of the metal is input. The information input in the input step S2 and the form thereof are not particularly limited, but it is necessary to include at least the type and form of information required for prediction using the first prediction model 10 and the second prediction model 20, which are built in the learning step S1.

In the prediction step S3, the information related to deterioration is predicted from the information input in the input step S2 on the basis of the first prediction model 10 and the second prediction model 20 constructed in the learning step S1. At this time, the derived information related to deterioration is different on the basis of the prediction model, but the type and form of the information related to the deterioration finally obtained through the prediction method according to the present invention is not particularly limited. For example, if the predicted information related to deterioration from the input information is the corrosion amount (mm), the information may be converted to weight and used as the final information related to deterioration, or may be converted to information classified as Deterioration I, II, III, IV based on the corrosion amount, for example.

The prediction device 200 according to the present embodiment includes an input unit 40, a learning unit 50, a prediction unit 60, and an output unit 70. The learning unit 50 derives the first prediction model 10 including the relationship between the information related to the environmental factors in the ground and the information related to the corrosion rate of the metal, and derives the second prediction model 20 including the relationship between the information including at least one piece of information related to the corrosion rate of the metal, and information related to deterioration. The input unit 40 has a function of receiving, as inputs, the information other than the information related to the corrosion rate of the metal among the information including at least one piece of the information related to the environmental factors in the ground or the information related to the corrosion rate of the metal. The prediction unit 60 has a function to predict the information related to deterioration from information input in the input unit 40 on the basis of the first prediction model 10 and the second prediction model 20 built by the learning unit 50. The output unit 70 has a function of displaying at least the information related to deterioration derived by the prediction unit 60.

The learning unit 50 builds the first prediction model 10 and the second prediction model 20 in the learning step S1. For example, it is possible to achieve this by using a personal computer provided with functions of calculation and data analysis using the statistical technique or the machine learning algorithm. Further, the learning unit 50 preferably has a function of storing the first prediction model 10 and the second prediction model 20 (hereinafter, the prediction model).

Furthermore, it is preferable to have a function of storing a plurality of prediction models. In this way, prediction can be performed by simply reading an existing prediction model stored by the learning unit 50 on the basis of the information input from the input unit 40. Furthermore, when predicting deterioration of any underground equipment for example, a plurality of prediction models which are stored in advance enable prediction to be performed by employing a prediction model of close conditions even without no prediction model corresponding to the target underground equipment, and moreover, enable prediction to be performed by selecting a prediction model appropriate for various underground equipment, or the like.

At least the input unit 40 has a function of receiving, as inputs, at least information other than information related to the corrosion rate of the metal among the information related to the environmental factors in the ground including at least information related to the soil particle size distribution, and information including the information related to the corrosion rate of the metal. The means and the form thereof are not in question, but can be easily achieved by a common personal computer or the like.

The prediction unit 60 has a function of predicting the information related to deterioration from the information input in the input unit 40 on the basis of at least the prediction model constructed by the learning unit 50. Although the means and the form thereof are not particularly limited, for example, it is possible to achieve this by using a personal computer provided with functions of calculation and data analysis using the statistical technique or the machine learning algorithm.

The output unit 70 has a function of outputting the information related to deterioration predicted in the prediction unit 60. The means and form thereof are not particularly limited, but a display of a personal computer or the like is easily conceivable.

As described above, with the prediction device 100, 200 according to the present embodiment, useful prediction is possible without performing measurement based on an electrochemical method, or even in cases where it is difficult to perform prediction using the statistical technique and the machine learning model. Note that in description of the embodiments above, the environment has been described by taking soil as an example, but the present invention is not limited to these examples. The environment may be in the atmosphere and in water.

The present disclosure is not limited to the embodiments described above, and modifications can be made within the scope thereof. For example, although the soil particle size distribution has been described as an example of the explanatory variable, the water content of the soil, chemical reaction species included in water in the soil, concentration of the chemical reactive species, conductivity, solubility of oxygen, temperature, and the like other than the soil particle size distribution may be used as the explanatory variable.

It is a matter of course that various embodiments and the like that are not described herein are also included in the present invention. Thus, the technical scope of the present invention is defined only invention-specific matters according to the claims that are appropriate based on the description above.

### INDUSTRIAL APPLICABILITY

In the present embodiment, a prediction device for predicting corrosion of underground equipment made of metal has been described as an example. However, the present invention is not limited to this example. Any number of the explanatory variables and the objective variables may be used. The present invention is applicable to prediction of a wide range of events.

### REFERENCE SIGNS LIST

10: First prediction model

20: Second prediction model

30: Third prediction model

40: Input unit

50: Learning unit

60: Prediction unit

70: Output unit

100, 200: Prediction device

1. A prediction device that predicts an objective variable desired to be predicted in a predetermined environment by using two or more prediction models, the prediction device comprising:
a first prediction model configured to output a characteristic representing a relationship with an event related to the objective variable from a change in a factor of the environment; and
a second prediction model configured to output information regarding an amount of change of the objective variable from the characteristic and an explanatory variable characterizing the environment.

2. The prediction device according to claim 1, wherein the first prediction model outputs the characteristic representing a relationship between a temporal change in water content of a soil environment and information related to a corrosion rate of a metal disposed in the soil environment, and the second prediction model outputs information related to a corrosion amount of the metal from the characteristic and information characterizing the soil environment.

3. The prediction device according to claim 1, wherein the first prediction model outputs the characteristic representing a relationship between a temporal change in a factor of a soil environment and information related to a corrosion rate of a metal disposed in the soil environment, and the second prediction model outputs information related to a corrosion amount of the metal from the characteristic and information characterizing the soil environment.

4. The prediction device according to claim 1, wherein
the first prediction model and the second prediction model are generated on a basis of a machine learning algorithm.

5. A prediction method performed by a prediction device, the method comprising:
outputting a characteristic representing a relationship with an event related to an objective variable desired to be predicted in a predetermined environment and time by using a first prediction model representing a relationship with the event from a change in an environmental factor of the environment; and
outputting the amount of change of the objective variable using a second prediction model that outputs information regarding the amount of change of the objective variable from the characteristic and an explanatory variable characterizing the environment.

6. The prediction device according to claim 2, wherein
the first prediction model and the second prediction model are generated on a basis of a machine learning algorithm.

7. The prediction device according to claim 3, wherein
the first prediction model and the second prediction model are generated on a basis of a machine learning algorithm.
